(19) United States
(12) Patent Application Publication
(10) Pub. No.: US 2004/0141285 A1
(43) Pub. Date: Jul. 22, 2004

(54) Modular computer system with passive backplane modules

(75) Inventors: Jean-Pierre Lefebvre, Boisbriand (CA); Philippe Muraglia, Boisbriand (CA); Rick Belair, Terrebonne (CA); Yan Adam, Sainte-Therese (CA)

Correspondence Address: OGILVY RENAULT, 1981 MCGILL COLLEGE AVENUE, SUITE 1600, MONTREAL, QC, H3A2Y3, CA

(73) Assignee: KONTRON COMMUNICATIONS INC., Boisbriand (CA)

(21) Appl. No.: 10/670,308

(22) Filed: Sep. 26, 2003

Related U.S. Application Data
(63) Continuation of application No. 10/369,691, filed on Feb. 21, 2003, now abandoned.
Application No. 10/369,691 is a continuation of application No. 10/202,674, filed on Jul. 25, 2002, now abandoned.

(51) Int. Cl. G06F 1/16

(52) U.S. Cl. 361/683

(57) ABSTRACT

An assembly of passive backplane modules that allows a variety of active boards of the same or of different architectures to be used in the same chassis. This technology differs from any others in that it presents a second level of modularity, in addition of the usual one which is putting active boards in a passive backplane. Here, in addition, several backplane modules of different types allow different architectures to be used on a slot by slot basis. Furthermore, wiring requirements to link those backplane modules are reduced to a strict minimum.

### FIELD OF THE INVENTION

This invention relates to computer systems and methods for interconnecting active boards together, using one or more passive backplane modules. In particular, it focuses on reduced cabling, high modularity, high density and high-speed interconnections.

### BACKGROUND OF THE INVENTION

A typical modern computer system is generally built using a passive backplane with removable active boards. The backplane allows using predefined bus architectures in a predefined system configuration.

For example, a PCI passive backplane has a slot for a host controller board and five slots for PCI peripheral expansion cards. In this case, the architecture is defined by the backplane to be a PCI bus and cannot be changed. Each time the architecture or the system configuration changes, such as the number of PCI expansion slots in this example, a whole new backplane is required.

To achieve modularity, it has been proposed to use computer systems with an adaptable passive backplane and plug-in circuit boards. However such modularity may work in the case of repair and/or upgrades for a given configuration but will not be fit for a change of architecture.

In other cases, to achieve modularity, different interconnected backplanes may be used to manage the different types of architecture and configuration required in a same chassis. In such case, power and other type of shared signals are provided to every backplanes using cables. This huge amount of cables is a penalty for system reliability and ease of maintenance. If cables need to be cleanly installed in the system to minimize the inconvenience, the assembly cost is impacted.

In U.S. Pat. No. 6,147,863 (Moore et al.), an industrial computer system comprises a passive backplane with a plugged-in CPU card which excludes the microprocessor, so that the CPU card and/or the microprocessor can be swappable. This invention does not accommodate a change of system architecture.

In U.S. Pat. No. 6,092,139 (Crane et al.) a computer system includes a passive backplane comprising a primary and secondary PCI bus system with a variable data path width corresponding to various data size of a pluggable central processing unit and a plurality of interconnected connector units for receiving circuit boards. This invention accommodates some changes of system configuration and particularly changes of microprocessors. However, the system architecture is still set by a single passive backplane that must be redesigned following almost any architectural changes, like increasing the number of expansion slots or adding support for another bus type.

In U.S. Pat. No. 6,052,276 (Do et al.), a computer system such as in an automatic bank teller terminal, comprises a passive backplane with a CPU board that has a plurality of I/O interfaces so as to reduce the need to upgrade the system overtime.

In U.S. Pat. No. 5,227,957 (Deters), a modular computer system is provided, having a unitary chassis with multiple bays, or a chassis assembled from interconnected bays, carrying slidable trays for plug-in attachment of conventional computer components, each tray interfacing one or more said components to a backplane connector board, and wherein the backplane is, in at least some cases, passive.

Therefore, there still appears to be a need for a generic solution for a modular computer system which can accommodate different system architectures and having backplane interconnections which eliminate almost all wire cables and still provide high performance communications between the circuit boards. Such a solution provides a common ground for very fast prototyping and allows easy customization and cost reduction for the volume production phase.

Definitions

| | |
|---|---|
| Active component | Any component using transistors. |
| Active board | A circuit board using any number of active components. |
| Architecture | A set of electrical and mechanical characteristics that devices or |
| | components have in common and that makes them compatible with |
| | each other. |
| AB Module, or | Auxiliary Backplane Module. Further described in the text. |
| ABM | |
| Backplane | A circuit board, or set of circuit boards, part of computer system |
| | which is usually passive and not installable by the system end user. |
| | Its function is to receive and interconnect two or several active |
| | boards that are usually field replaceable by the end user. |
| Backplane | A passive circuit board that consists of a part of the whole |
| Module | backplane. Two or more backplane modules are used together to |
| | make a complete usable backplane. |
| Circuit board, or | A printed circuit board with any type of electrical component |
| Board, or Card | assembly. May be removable or not by the end user. |
| Compact PCI, or | A standardized computer system architecture compliant to one or |
| cPCI | several of the PICMG 2.x standards. |
| CPU | Central Processing Unit |
| H.110 | Refers to the H.110 specification of PICMG, or to an application |
| | directly derived from it. |
| Host controller | CPU board that is the central resource in the system. |
| Node slot | Location in the system to insert a board that is considered a node in |
| | relation to a switch fabric architecture. |
| Passive board | A circuit board using no active components. |
| PCI | Peripheral Component Interconnect. Underlying bus architecture of |
| | a cPCI system. |
| PICMG | PCI Industrial Manufacturer Group. |
| PSD Module, or | Power and Signal Distribution Module. Further described in the |
| PSDM | text. |
| SBC | Single Board Computer. A highly integrated circuit board that has |
| | most or all of the usual components needed to make a fully |
| | operational computer. |
| Slot | Refers to a location in a chassis intended to receive a removable |
| | circuit board. In this document, it generally refers to a cPCI slot as |
| | defined in the PICMG 2.0 standard. |
| Switch Fabric | A computer system architecture where circuit boards communicate |
| | with each other using point-to-point connections going through a |
| | switch, or a network of switches, instead of, or in addition to using |
| | a set of bussed signals. |
| Switch Slot | Location in the system to insert a board that is considered a switch |
| | in regard to a switch fabric architecture. |
| System | Refers to the quantity, dimension, type, and position of the active |
| configuration | boards, fans, hard disks or any other configurable device in a |
| | system. |

### SUMMARY OF THE INVENTION

This invention consists of a set of backplane modules. The main module is called the Power and Signal Distribution Module (further called PSDM or PSD Module). The PSDM is used as a signal distributor and a receptacle for a variable set of auxiliary backplane modules (ABM or AB Module). This PSD Module provides the infrastructure to implement power distribution, management signal distribution and high-speed point to point signal distribution between several node slots and one or more switch slots.

Auxiliary backplane modules designed to mate on the PSDM are also passive but allow inserting active devices in a system. These are the actual backplane modules that determine the kind of active boards or devices that may be used in a particular slot. These AB Modules may be of any kind: Compact PCI, VME, H.110, CPSB, SCSI etc. Expected AB Modules for the preferred embodiment are related to, but not limited to the Compact PCI architecture. When the PSD Modules and a selected set of auxiliary modules are used together, the assembly constitutes one logical backplane to be used in a chassis.

### BRIEF DESCRIPTION OF THE DRAWINGS

FIG. 1 represents the logical scheme of the preferred embodiment;

FIG. 2 represents a front view of the preferred embodiment;

FIG. 3 represents a rear view of the preferred embodiment;

FIG. 4 is a side view of the preferred embodiment;

FIG. 5 is a detailed three-dimensional view for a variation of the preferred embodiment.

### DETAILED DESCRIPTION OF THE INVENTION

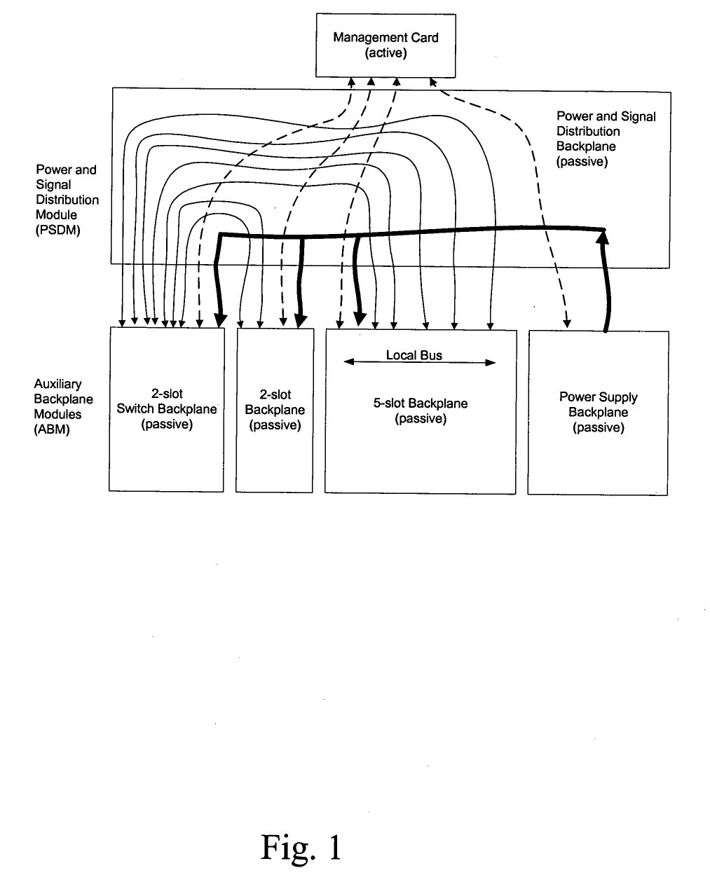

The computer system of this invention consists of a main backplane module, the PSDM, and a number of auxiliary backplane modules specific to the devices to be used in the system. The PSDM allows distribution of power, management signals and high-speed serial bus to each selected slot within a chassis. The number of slots is dependent of the selected embodiment. In a typical Compact PCI implementation, the preferred embodiment, 21 slots are supported. FIGS. 1 to 5 show how the AB Modules are attached to the PSDM. This infrastructure opens the door to two types of data path. One is a parallel bus self-contained in a multi-slot AB Module and the other is a serial point to point bus routed through the PSD Module from each slot to a dedicated switch fabric slot. The PSDM may host one or more serial links per node slot and one or more switch fabric slot.

Connector/Bus bar

In order to connect the PSDM to the AB Module, each slot has a high-density connector and/or direct connection to a high current copper bus bar sitting on the PSDM. The connector is used to provide power and other signals. Direct copper connections may be used mainly for the power supply backplane module(s), which require more current. Other connectors may be used on the PSDM for active boards, like the Management Card shown on FIG. 1.

PSDM slot particularities

Some slots may have particularities. For example, power supplies may have dedicated slots with a special pinout. Serial bus connections are point to point and must connect to a switch fabric. This switch fabric must be located in a particular slot that has a special pinout to accommodate the higher number of connections to the PSDM.

Serial Bus

High-speed differential pairs are provided to selected slots on the PSDM. What defines the exact nature of the signals is the chosen architecture. For example, the preferred embodiment distributes PICMG2.16 compliant signals. It consists of Ethernet signaling requiring 100 Ohms CAT5 cabling. A second serial channel may be provided that consists of 100 Ohms differential pairs supporting multi-gigabit rate. Once the physical medium is fixed, the specific active boards used in the system will define the exact nature of the serial bus in term of protocol.

Optical Bus

In some future embodiments, it should be possible to use optical data paths in the PSDM and ABM and using special optical connectors for that purpose. In such a case, the same modular approach will consist also of optical point to point bus.

Other components

The PSDM not only accepts ABM on a slot per slot basis, it can also accept directly some predefined active boards or other devices like fans.

Now, referring to the figures, FIG. 1 represents the logical scheme of the modular backplane system of the invention. On FIG. 1, normal lines represent serial point to point bus connections. Dashed lines represent management connections. Bold lines represent power distribution. Regardless of the possible physical implementations of this topology, this drawing summarizes the whole idea of interconnecting various backplanes (ABMs) on a central one (PSDM). FIG. 1 shows the PSDM providing the central interconnections of the system, like power distribution, system management signals, and high-speed interconnections. Choosing what power rails to implement, what management signals to use and defining the high-speed serial data paths sets the limits of the system and will depend on its end purpose. In the preferred embodiment these choices are related to the various Compact PCI specifications from the PICMG organization. It is however possible to specialize each ABM with functionality that is not shared by the PSDM and other ABMs. This is shown by the “Local Bus” identifier in FIG. 1. In the Compact PCI embodiment, this could be a PCI or a H.110 bus for example.

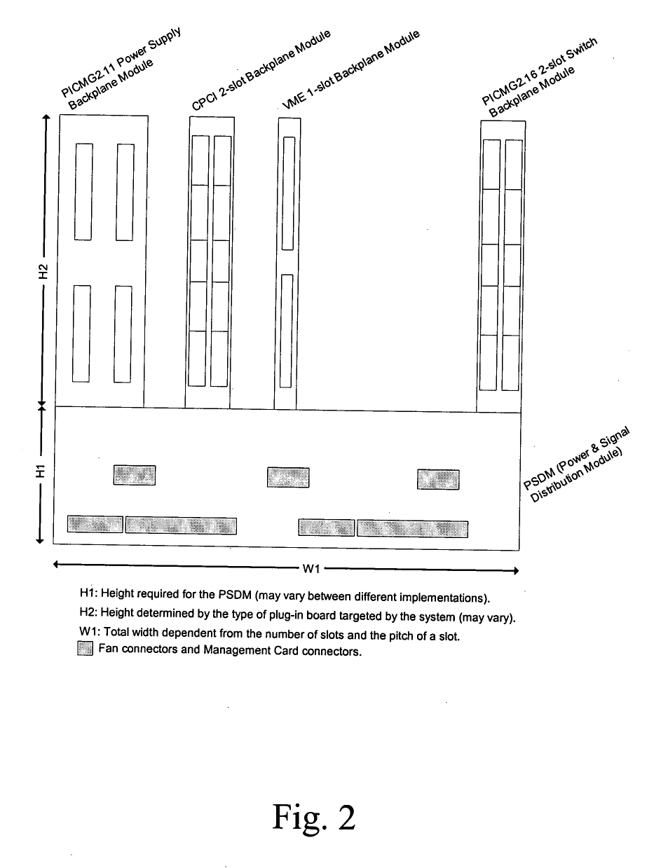

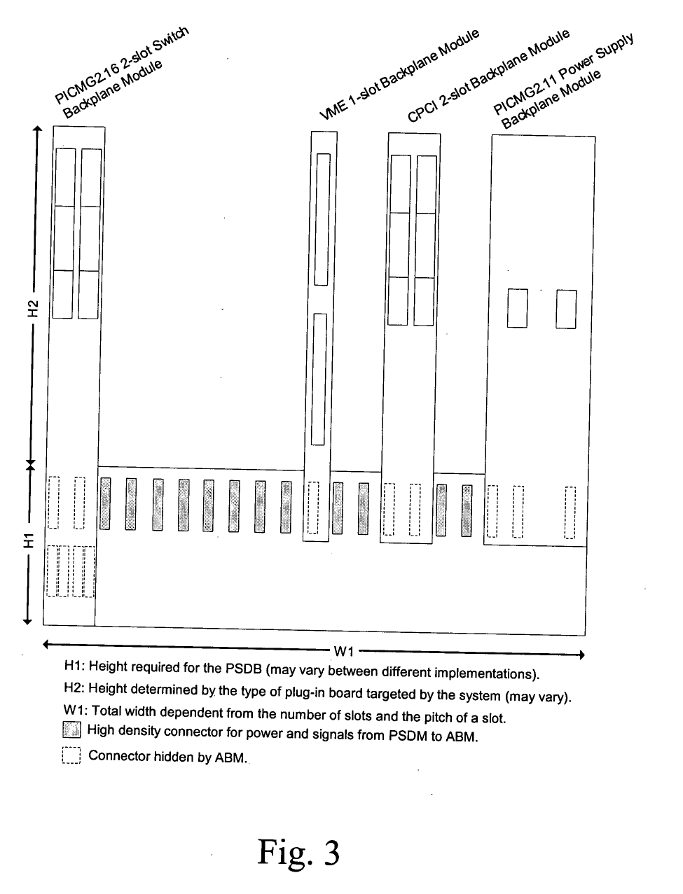

FIGS. 2 and 3 are the front and rear views of the preferred embodiment. Vertical backplanes (ABM) matching FIG. 1 can be identified by their label. Active boards in that scenario are plugged into the ABMs from the front. The rear connection is reserved for rear transition module (RTM) as stated in the Compact PCI specification. The VME backplane in FIGS. 2 and 3 shows that a broad range of standards could be mixed in the same system. The connector area between PSDM to ABM is clearly visible and is such that any ABM can be moved to any slot position. This is not mandatory but it is in the philosophy of the modular system to allow any combination of ABMs.

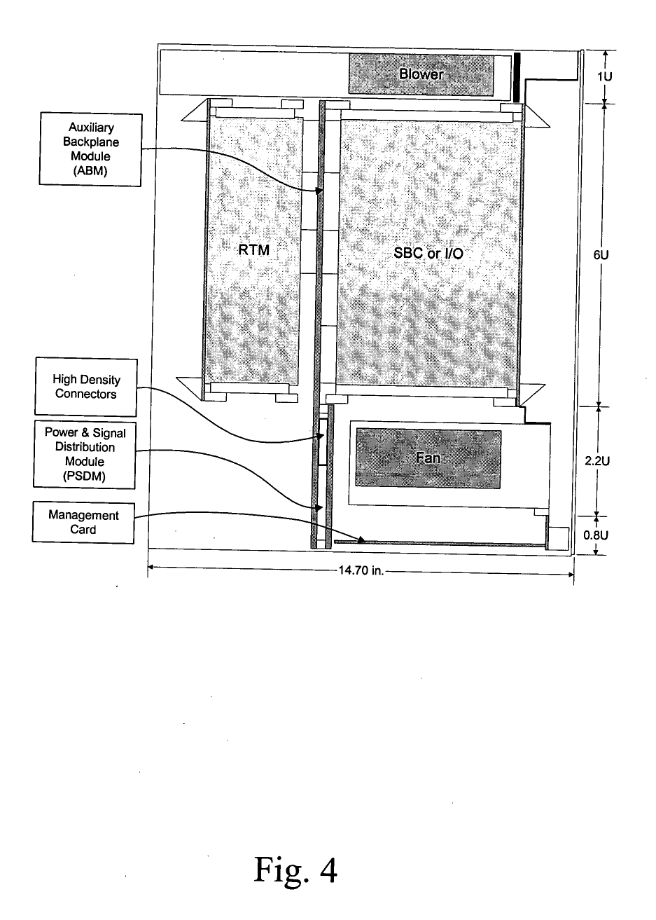

FIG. 4 is a representation of the preferred embodiment prototype. It clearly shows the various interconnection areas, the two-level backplane system (PSDM and ABM), and the active board regions (labeled SBC or I/O, RTM, and System Management Card). Some active boards are connected directly to the PSDM, as previously stated, and others are connected in the ABM zone. This drawing also shows a typical mechanical envelope for the chassis with the fans and blowers required for cooling active boards.

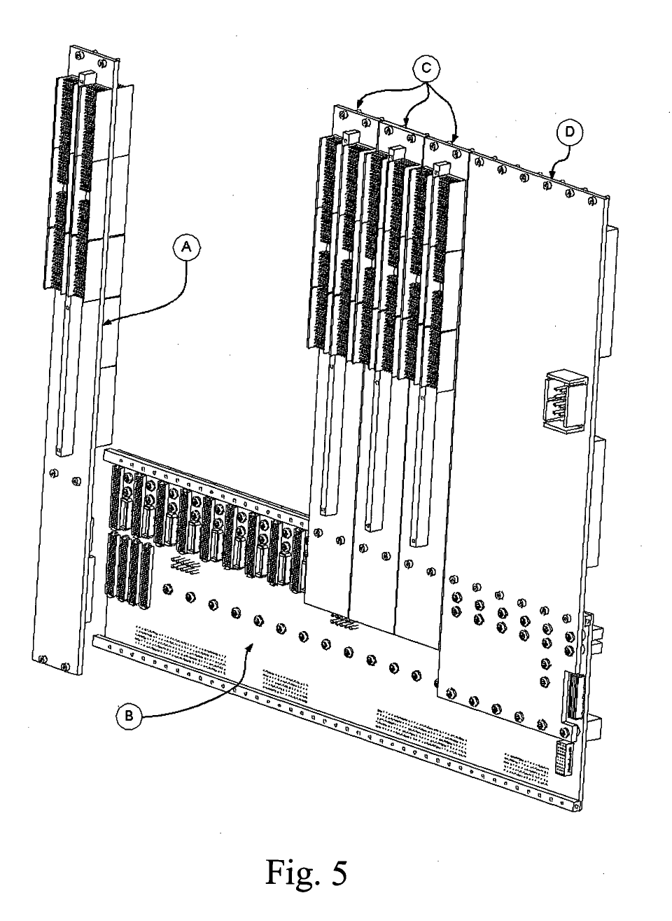

FIG. 5 provides a more detailed view of the backplanes for a variation of the preferred embodiment. In this figure, (A) represents the 2-slot switch ABM used with switch fabric active boards, (B) is the PSDM, (C) shows three occurrences of a 2-slot ABM used with single board computers, and (D) is the power supply ABM. All these ABMs relate to the ones in FIG. 4. The assembly is seen from the rear, similarly to FIG. 3, to show the high density interconnection system between the PSDM (B) and the various ABMs. On ABMs (A) and (C), many multi-pin connectors can be seen on the upper end, these are the standard Compact PCI connectors. Power supply ABM (D) has also a smaller 8-pin connector. This one is not related to any standard and is used for power input to the chassis. This illustrates how some ABMs may be designed to be completely compliant with an existing standard, while others may have some proprietary interconnections.

Although the invention has been described and illustrated with respect to a preferred embodiment, it is not limited thereto, except as defined in the appended claims.

What is claimed is:

1. A computer system comprising a plurality of distinct backplane modules wherein:
a) a first backplane module comprises a plurality of connectors to receive power from one or several power supply backplane modules to distribute said power to the backplane modules other than first module and than said power backplane modules, and
b) said first backplane module may also comprise a plurality of connectors to establish high-speed point-to-point connections to distribute data to some, or all other backplane modules, and
c) same first backplane module may also comprise a plurality of connectors to establish connections between an active management card and some, or all the other backplane modules to distribute management signals from said card, and
d) all the backplane modules may be passive, and
e) all the backplane modules except the power backplane modules may receive power and data through the connectors of the first backplane module, and
f) all the backplane modules may receive management signals through the connectors of the first backplane module.

2. The computer system of claim 1 where the high-speed point-to-point data connections are being routed to one, or several switched fabric backplane modules, and/or to one or several active switch fabric cards using one or more connectors of said first backplane module.

3. The computer system of claim 2 where said high-speed point-to-point data connections use optical links and connectors.
